(19) United States
(12) Patent Application Publication
(10) Pub. No.: US 2019/0064425 A1
(43) Pub. Date: Feb. 28, 2019

(54) Light Guide Film

(71) Applicant: Sichuan Longhua Film Co., Ltd, Mianyang (CN)

(72) Inventors: Rui-Min Diao, Mianyang (CN); Yao-Chang Wang, Zhubei City (TW)

(73) Assignee: Sichuan Longhua Film Co., Ltd, Mianyang (CN)

(21) Appl. No.: 16/106,983

(22) Filed: Aug. 21, 2018

(30) Foreign Application Priority Data
Aug. 24, 2017 (CN) 201710736981.X

(51) Int. Cl. F21V 8/00; G02B 6/42; G02B 5/02

(52) U.S. Cl. CPC G02B 6/0066; G02B 6/4298; G02B 5/0268; G02B 6/0053; G02B 6/0038; G02B 6/0016

(57) ABSTRACT

A light guide film includes at least one wedge-shaped light incident portion and a light exit sheet. The wedge-shaped light incident portion has a light incident side surface and a connection side opposite to the light incident side surface. A thickness at the light incident side surface of the wedge-shaped light incident portion is greater than a thickness at the connection side of the wedge-shaped light incident portion. The light exit sheet is connected to the connection side and extends from the connection side. The light exit sheet has a light exit surface. The wedge-shaped light incident portion protrudes from the light exit surface. The light incident side surface is for receiving a light. The light is emitted from the light exit surface. The light exit sheet and the wedge-shaped light incident portions are integrally formed into one.

### FIELD OF THE INVENTION

The present invention relates to a light guide film, and more particularly to a light guide film in which a light exit sheet and a wedge-shaped light incident portion are integrally formed into one.

### BACKGROUND OF THE INVENTION

In general, some common light sources such as light emitting diodes (LEDs) or cold cathode fluorescent lamps (CCFLs) are usually disposed at the position of a light incident side surface of a light guide film. By this, a light emitted by the light source can be incident into the light guide film from the light incident side surface, and then emitted from a light exit surface of the light guide film through the guide of the light guide film, and a surface light source with uniform luminance is provided.

However, the widths of the light exit surfaces of the current light emitting diodes are already greater than the thicknesses of the light guide films. Therefore, when the light guide film is further thinned to meet the trend of thinning of existing electronic devices (such as light-emitting keyboards and smart phones), the light of the light emitting diode cannot be effectively transmitted into the light guide film, resulting in poor light usage efficiency and light leakage. This causes that thinned electronic devices need to use more light-emitting diodes or higher drive currents to compensate for the lack of luminance.

### SUMMARY OF THE INVENTION

The present invention provides a light guide film, which can enhance the usage efficiency of a light source and reduce light leakage.

The present invention provides a light guide film, including at least one wedge-shaped light incident portion and a light exit sheet. The wedge-shaped light incident portion has a light incident side surface and a connection side opposite to the light incident side surface. A thickness at the light incident side surface of the wedge-shaped light incident portion is greater than a thickness at the connection side of the wedge-shaped light incident portion. The light exit sheet is connected to the connection side and extends from the connection side. The light exit sheet has a light exit surface. The wedge-shaped light incident portion protrudes from the light exit surface. The light incident side surface can receive a light. The light exits from the light exit surface. The light exit sheet and the wedge-shaped light incident portions are integrally formed into one.

In one of the embodiments of the present invention, the light exit sheet further has an optical microstructure formed at the light exit surface. The optical microstructure deflects the light.

In one of the embodiments of the present invention, the optical microstructure includes a plurality of side-by-side prism units. The prism units and the light incident side surface run in the same direction.

In one of the embodiments of the present invention, the optical microstructure includes a plurality of side-by-side V-cut grooves. The V-cut grooves and the light incident side surface run in the same direction.

In one of the embodiments of the present invention, the optical microstructure includes a plurality of side-by-side columnar structures.

In one of the embodiments of the present invention, the columnar structures and the light incident side surface run in the same direction.

In one of the embodiments of the present invention, each of the columnar structures has a convex cylindrical surface.

In one of the embodiments of the present invention, each of the columnar structures has a concave cylindrical surface.

In one of the embodiments of the present invention, the light exit sheet further has a back surface opposite to the light exit surface and a scattering microstructure formed at the back surface. The scattering microstructure is used for scattering the light in the light exit sheet.

In one of the embodiments of the present invention, the light exit sheet further has a back surface opposite to the light exit surface. The wedge-shaped light incident portion further protrudes from the back surface.

In one of the embodiments of the present invention, the wedge-shaped light incident portion further has a diffusing structure formed at the light incident side surface. The diffusing structure is used for diverging the light incident to the light incident side surface.

In one of the embodiments of the present invention, the wedge-shaped light incident portion further has a first plane and a second plane. The first plane is opposite to the second plane. The first plane and the second plane are located between the light incident side surface and the connection side. The light exit surface is adjacent to the first plane and extends from a side of the first plane. The first plane is inclined relative to the light exit surface.

In one of the embodiments of the present invention, the diffusing structure includes a plurality of side-by-side prismatic structures. The prismatic structures are arranged at the light incident side surface and along the light incident side surface.

In one of the embodiments of the present invention, the light exit sheet further has a back surface opposite to the light exit surface. The back surface is adjacent to the second plane and extends from a side of the second plane.

In one of the embodiments of the present invention, the second plane is inclined relative to the back surface.

In one of the embodiments of the present invention, the second plane is flush with the back surface.

In one of the embodiments of the present invention, a material constituting the light guide film includes polycarbonate.

In one of the embodiments of the present invention, the wedge-shaped light incident portion further has a connection surface, which is located between the light incident side surface and the connection side. The connection surface includes a first connection plane and a second connection plane. The light exit surface of the light exit sheet is adjacent to the first connection plane and extends from a side of the first connection plane. The other side of the first connection plane is adjacent to a side of the second connection plane. The other side of the second connection plane is adjacent to the light incident side surface. The first connection plane is not parallel to the second connection plane.

In one of the embodiments of the present invention, a thickness of the light exit sheet is between 0.1 mm and 0.4 mm. A thickness of the light incident side surface of the wedge-shaped light incident portion is between 0.3 mm and 0.5 mm.

In the light guide film provided by the above embodiments of the present invention, since the thickness at the light incident side surface of the wedge-shaped light incident portion is greater than the thickness at the connection side of the wedge-shaped light incident portion (equivalent to the thickness of the light exit sheet), the usage efficiency of the light source can be enhanced and the occurrence of light leakage can be reduced.

The above description is only an overview of the technical solutions of the present invention. In order to more clearly understand the technical means of the present invention, which can be implemented in accordance with the contents of the specification, and in order that the above-mentioned and other objectives, features and advantages of the present invention can be more clearly understood, the embodiments are described below in detail with reference to the accompanying drawings.

### BRIEF DESCRIPTION OF THE DRAWINGS

The present invention will become more readily apparent to those ordinarily skilled in the art after reviewing the following detailed description and accompanying drawings, in which:

FIG. 1A is a schematic cross-sectional view of a light guide film in accordance with an embodiment of the present invention;

FIG. 1B is a schematic perspective view of a manufacturing method of a light guide film in accordance with an embodiment of the present invention;

FIG. 2A is a schematic cross-sectional view of a light guide film in accordance with another embodiment of the present invention;

FIG. 2B is a schematic perspective view of a manufacturing method of a light guide film in accordance with another embodiment of the present invention;

FIG. 3A is a schematic cross-sectional view of a light guide film in accordance with yet another embodiment of the present invention;

FIG. 3B is a schematic perspective view of a manufacturing method of a light guide film in accordance with yet another embodiment of the present invention;

FIG. 4A is a schematic cross-sectional view of a light guide film in accordance with yet another embodiment of the present invention;

FIG. 4B is a schematic perspective view of a manufacturing method of a light guide film in accordance with yet another embodiment of the present invention;

FIG. 5A is a schematic cross-sectional view of a light guide film in accordance with yet another embodiment of the present invention;

FIG. 5B is a schematic cross-sectional view of a light guide film in accordance with yet another embodiment of the present invention;

FIG. 5C is a schematic cross-sectional view of a light guide film in accordance with yet another embodiment of the present invention;

FIG. 5D is a schematic cross-sectional view of a light guide film in accordance with yet another embodiment of the present invention;

FIG. 6A is a schematic cross-sectional view of a light guide film in accordance with yet another embodiment of the present invention; and

FIG. 6B is a schematic top view of a light guide film in accordance with yet another embodiment of the present invention.

### DETAILED DESCRIPTION OF EMBODIMENTS

The present invention will now be described more specifically with reference to the following embodiments. The aforementioned and other technical contents, features and effectiveness of the present invention are clearly presented in the following detailed description of an embodiment in conjunction with the reference drawings. In the following detailed description of the embodiments, reference is made to the accompanying drawings which form a part hereof, and in which is shown by way of illustration specific embodiments in which the invention may be practiced. In this regard, directional terminology, such as “upper”, “lower”, “left”, “right”, “front”, or “back”, etc., is used with reference to the orientation of the Figure(s) being described. The components of the invention can be positioned in a number of different orientations. As such, the directional terminology is used for purposes of illustration and is in no way limiting. It is to be noted that the following descriptions of embodiments of this invention are presented herein for purpose of illustration and description only. It is not intended to be exhaustive or to be limited to the precise form disclosed.

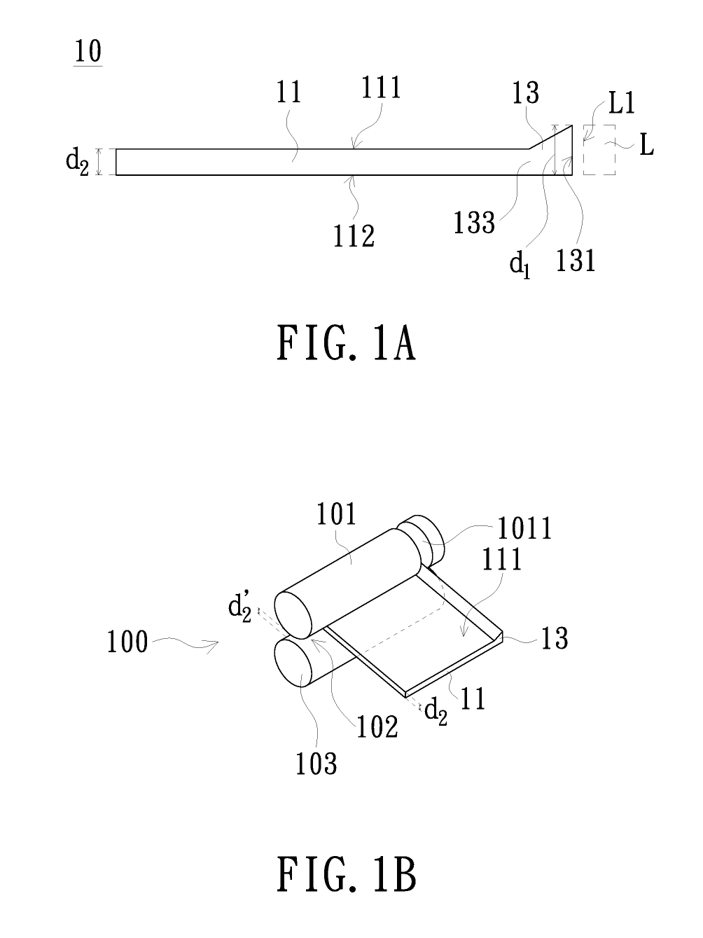

Please refer to FIG. 1A. FIG. 1A is a schematic view of a light guide film in accordance with an embodiment of the present invention, and is a schematic cross-sectional view of a light guide film 10. The light guide film 10 includes a light exit sheet 11 and a wedge-shaped light incident portion 13. The wedge-shaped light incident portion 13 has a light incident side surface 131 and a connection side 133 opposite to the light incident side surface 131. A thickness d1 at the light incident side surface 131 of the wedge-shaped light incident portion 13 is greater than a thickness d2 at the connection side 133 of the wedge-shaped light incident portion 13. The light exit sheet 11 is connected to the connection side 133 and extends from the connection side 133. The light exit sheet 11 and the wedge-shaped light incident portion 13 are integrally formed into one. In other words, there is no boundary between the light exit sheet 11 and the wedge-shaped light incident portion 13.

The light exit sheet 11 has a light exit surface 111. The wedge-shaped light incident portion 13 protrudes from the light exit surface 111. The light incident side surface 131 of the wedge-shaped light incident portion 13 is for receiving a light. The light may be generated, for example, by a light source L attached to the light incident side surface 131. The light source L may be, for example, a light emitting diode or a cold cathode fluorescent lamp or other light source. The light incident to the wedge-shaped light incident portion 13 of the light guide film 10 can be incident to the light exit sheet 11 via the connection side 133, and then the incident light can be emitted from the light exit surface 111 to generate a surface light source. Optical microstructures (not shown in the figure) may be formed at the light exit surface 111 of the light exit sheet 11 and/or on a back surface 112 opposite to the light exit surface 111. The optical microstructures can deflect the light so that the light incident to the light exit sheet 11 can be emitted from the light exit surface 111.

Since the thickness d1 at the light incident side surface 131 of the wedge-shaped light incident portion 13 is greater than the thickness d2 at the connection side 133 of the wedge-shaped light incident portion 13, the light guide film 10 has the light incident side surface 131 whose thickness is greater than the thickness d2 of the light exit sheet 11. Therefore, the thickness d1 of the light incident side surface 131 of the light guide film 10 may be designed to match a width of a light exit side surface L1 of the light source L, so as to enhance the usage efficiency of the light source L and reduce the occurrence of light leakage. The light guide film 10 may still have the light exit sheet 11 with thinner thickness. This can effectively solve the problem of poor light usage efficiency and light leakage caused by that a thickness of a light guide film is less than a width of a light exit side surface of a light source in the prior art. The light exit sheet 11 and the wedge-shaped light incident portion 13 are integrally formed into one, and thus there is no boundary between the light exit sheet 11 and the wedge-shaped light incident portion 13, so that the light incident to the wedge-shaped light incident portion 13 basically does not refract and reflect between the light exit sheet 11 and the wedge-shaped light incident portion 13. Thus, the light can be emitted from the light exit sheet 11 as much as possible, so as to reduce the loss of the light.

A material constituting the light guide film 10 may include, for example, polycarbonate, but the present invention is not limited thereto. In addition, in an embodiment of the present invention, the thickness d2 of the light exit sheet 11 is between 0.1 mm and 0.4 mm, and the thickness d1 of the light incident side surface 131 of the wedge-shaped light incident portion 13 is between 0.3 mm and 0.5 mm, but the present invention is not limited thereto.

Please refer to FIG. 1A and FIG. 1B. FIG. 1B is a schematic view of a manufacturing method of the light guide film 10 in FIG. 1A. As shown in FIG. 1B, a light guide film manufacturing equipment 100 includes a first roller 101, a second roller 103, and a feeding device (not shown in the figure). Between the first roller 101 and the second roller 103, there is a gap 102 corresponding to the thickness d2 of the light exit sheet 11. The first roller 101 has a groove 1011 corresponding to the wedge-shaped light incident portion 13. The feeding device may be disposed at a side of the first roller 101 and the second roller 103. A discharge port of the feeding device (not shown in the figure) may be adjacent to the gap 102.

In the present embodiment, the light guide film 10 is manufactured by a continuous hot rolling process. The feeding device may heat materials such as polycarbonate, etc., to a molten state, and continuously output the materials from the discharge port into the gap 102 of the first roller 101 and the second roller 103. The first roller 101 and the second roller 103 may, for example, be driven to rotate by a device such as a motor, etc. (not shown in the figure), so that the material outputted by the feeding device is extruded in a roll molding manner into a sheet form and outputted to the other side. The rotation directions of the first roller 101 and the second roller 103 are opposite to each other. The rotation directions are such that the material outputted by the feeding device can be extruded to the other side relative to the feeding device.

The gap 102 between the first roller 101 and the second roller 103 has a spacing d2′. The size of the spacing d2′ depends on the characteristics of the material used. Since the material used may shrink or expand after cooling, the size of the spacing d2′ is set by a user to a size with which a light exit sheet having a thickness of d2 can be produced after the material is outputted with roll molding. Since the first roller 101 has the groove 1011 corresponding to the wedge-shaped light incident portion 13, when the material outputted by the feeding device is extruded into a sheet form and outputted by the first roller 101 and the second roller 103, the wedge-shaped light incident portion 13 and the light exit sheet 11 integrally formed into one can be produced at a place corresponding to the groove 1011. There is no boundary between the light exit sheet 11 and the wedge-shaped light incident portion 13. Therefore, by using the groove 1011 provided by the first roller 101, the light guiding film 10 where the light exit sheet 11 and the wedge-shaped light incident portion 13 are integrally formed into one can be manufactured in the present embodiment by using the continuous hot rolling process, so as to facilitate rapid mass production of the light guide film 10 and reduce a cost.

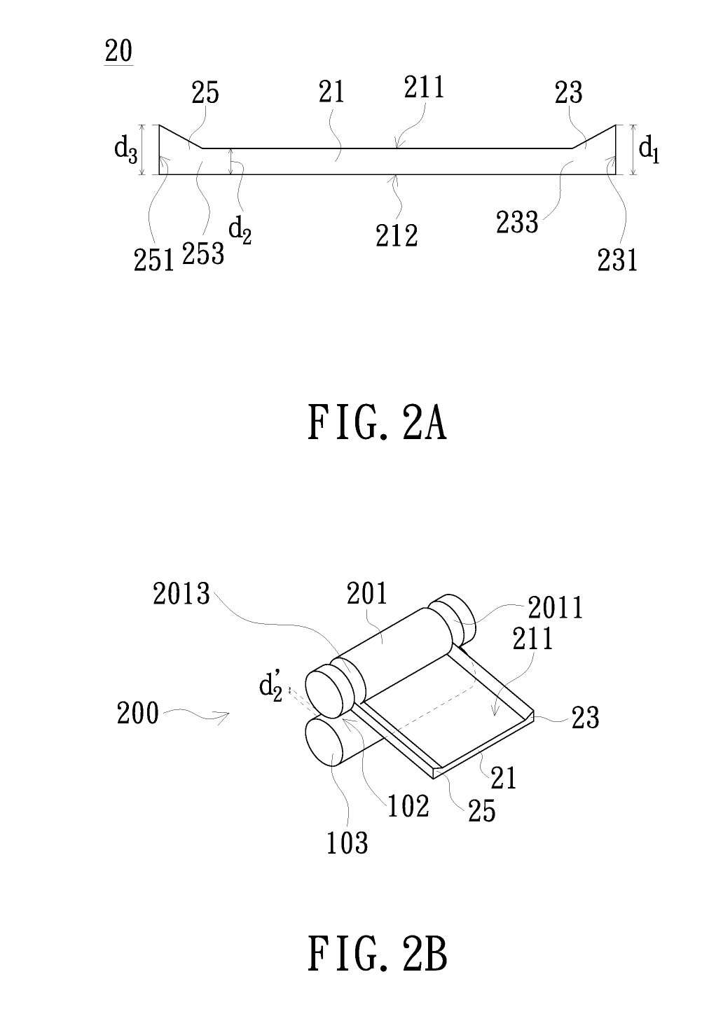

Please refer to FIG. 2A and FIG. 2B. FIG. 2A is a schematic cross-sectional view of a light guide film in accordance with another embodiment of the present invention. FIG. 2B is a schematic perspective view of a manufacturing method of a light guide film in accordance with another embodiment of the present invention. A light guide film 20 of the present embodiment and the light guide film 10 of the embodiment illustrated in FIG. 1A and FIG. 1B have similar structures and the same function and efficacy. The difference between the present embodiment and the embodiment illustrated in FIG. 1A and FIG. 1B is that the light guide film 20 further has a wedge-shaped light incident portion 25, and the wedge-shaped light incident portion 25 is formed on a light exit sheet 21 at the other side opposite to a wedge-shaped light incident portion 23.

The wedge-shaped light incident portion 25 has a light incident side surface 251 and a connection side 253 opposite to the light incident side surface 251. A thickness d3 at the light incident side surface 251 of the wedge-shaped light incident portion 25 is greater than the thickness d2 at the connection side 253 of the wedge-shaped light incident portion 25. The light exit sheet 21 is connected to the connection side 253 and extends from the connection side 253. The light exit sheet 21 and the wedge-shaped light incident portion 23 of the present embodiment may be the same as the light exit sheet 11 and the wedge-shaped light incident portion 13 of the aforementioned embodiment. The light exit sheet 21, the wedge-shaped light incident portion 23, and the wedge-shaped light incident portion 25 are integrally formed into one. There is no boundary between the light exit sheet 21 and the wedge-shaped light incident portions 23 and 25.

The wedge-shaped light incident portion 25 protrudes from a light exit surface 211. The light incident side surface 251 of the wedge-shaped light incident portion 25 is for receiving a light generated by a light source (not shown in the figure). The light incident to the wedge-shaped light incident portion 25 of the light guide film 20 can be incident into the light exit sheet 21 via the connection side 253. Since the thickness d3 at the light incident side surface 251 of the wedge-shaped light incident portion 25 is greater than the thickness d2 at the connection side 253 of the wedge-shaped light incident portion 25, the thickness d3 of the light incident side surface 251 of the light guide film 20 can be matched with the width of the light exit side surface of the light source, so as to enhance the usage efficiency of the light source and reduce the occurrence of light leakage. The light exit sheet 21 and the wedge-shaped light incident portion 25 are integrally formed into one, and thus there is no boundary between the light exit sheet 21 and the wedge-shaped light incident portion 25, so that the light incident to the wedge-shaped light incident portion 25 can be more efficiently incident into the light exit sheet 21.

Please refer to FIG. 2B. The difference between a light guide film manufacturing equipment 200 and the light guide film manufacturing equipment 100 illustrated in FIG. 1B is that a first roller 201 of the light guide film manufacturing equipment 200 has a groove 2013 corresponding to the wedge-shaped light incidental portion 25. A groove 2011 of the first roller 201 may be the same as the groove 1011 of the first roller 101 of the aforementioned embodiment. Therefore, when the material outputted by the feeding device (not shown in the figure) is extruded into a sheet form and outputted by the first roller 201 and the second roller 103, the wedge-shaped light incident portion 23, the wedge-shaped light incident portion 25, and the light exit sheet 21 that are integrally formed into one can be produced at a place corresponding to the groove 2013. There is no boundary between the light exit sheet 21 and the wedge-shaped light incident portion 23 and the wedge-shaped light incident portion 25.

Thus, through the disposition of the groove 2011 corresponding to the wedge-shaped light incident portion 23 and the groove 2013 corresponding to the wedge-shaped light incident portion 25 at the first roller 201, the light guide film 20 in which the light exit sheet 21, the wedge-shaped light incident portions 23 and 25 are integrally formed into one can be manufactured in the present embodiment by using the continuous hot rolling process, so as to facilitate rapid mass production of the light guide film 20 and reduce the cost.

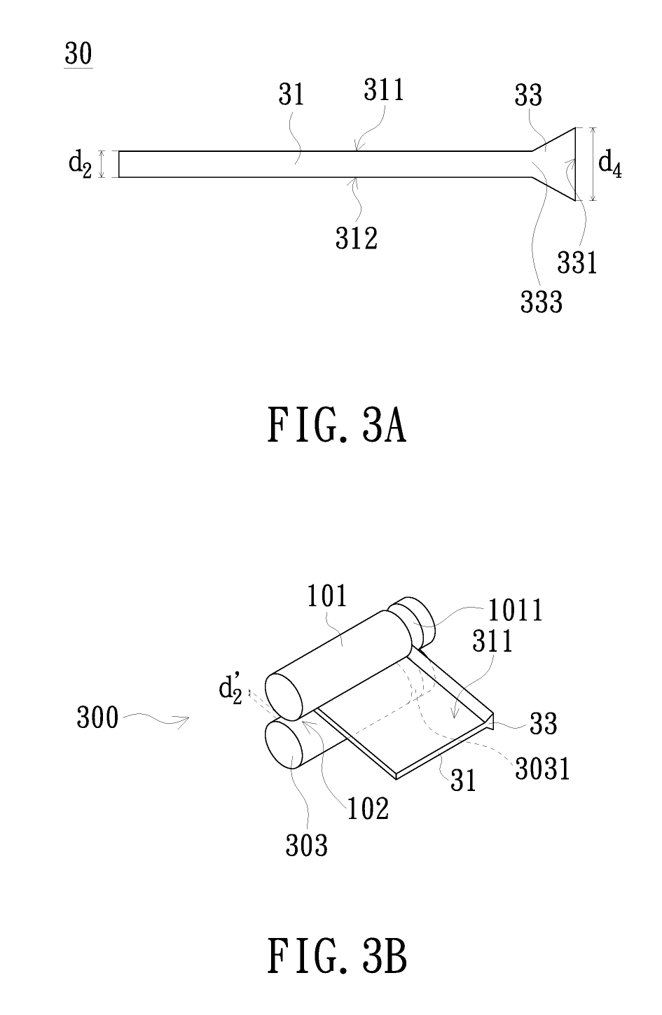

Please refer to FIG. 3A and FIG. 3B. FIG. 3A is a schematic cross-sectional view of a light guide film in accordance with yet another embodiment of the present invention. FIG. 3B is a schematic perspective view of a manufacturing method of a light guide film in accordance with yet another embodiment of the present invention. A light guide film 30 of the present embodiment and the light guide film 10 of the embodiment illustrated in FIG. 1A and FIG. 1B have similar structures and the same function and efficacy. The difference between the present embodiment and the embodiment illustrated in FIG. 1A and FIG. 1B is that a wedge-shaped light incident portion 33 of the light guide film 30 has a light incident side surface 331 and a connection side 333 opposite to the light incident side surface 331. A thickness d4 at the light incident side surface 331 of the wedge-shaped light incident portion 33 is greater than the thickness d2 at the connection side 333 of the wedge-shaped light incident portion 33. The wedge-shaped light incident portion 33 protrudes from a light exit surface 311 and a back surface 312 opposite to the light exit surface 311. A light exit sheet 31 is connected to the connection side 333 and extends from the connection side 333. The light exit sheet 31 of the present embodiment may be the same as the light exit sheet 11 of the aforementioned embodiment. The light exit sheet 31 and the wedge-shaped light incident portion 33 are integrally formed into one. There is no boundary between the light exit sheet 31 and the wedge-shaped light incident portion 33.

The light incident side surface 331 of the wedge-shaped light incident portion 33 is for receiving a light generated by a light source (not shown in the figure). The light incident to the wedge-shaped light incident portion 33 can be incident into the light exit sheet 31 via the connection side 333. Since the thickness d4 at the light incident side surface 331 of the wedge-shaped light incident portion 33 is greater than the thickness d2 at the connection side 333 of the wedge-shaped light incident portion 33, the thickness d4 of the light incident side surface 331 of the light guide film 30 may be designed to match the width of the light exit side surface of the light source, so as to enhance the usage efficiency of the light source and reduce the occurrence of light leakage. Since the light exit sheet 31 and the wedge-shaped light incident portion 33 are integrally formed into one, and thus there is no boundary between the light exit sheet 31 and the wedge-shaped light incident portion 33, the light incident to the wedge-shaped light incident portion 33 can be more efficiently incident into the light exit sheet 31.

Please refer to FIG. 3B. The difference between a light guide film manufacturing equipment 300 and the light guide film manufacturing equipment 100 illustrated in FIG. 1B is that a second roller 303 of the light guide film manufacturing equipment 300 further has a groove 3031 corresponding to the wedge-shaped light incident portion 33. Therefore, when the material outputted by the feeding device (not shown in the figure) is extruded into a sheet form and outputted by the first roller 101 and the second roller 303, the wedge-shaped light incident portion 33 and the light exit sheet 31 integrally formed into one can be produced at a place corresponding to the groove 1011 and the groove 3031. There is no boundary between the light exit sheet 31 and the wedge-shaped light incident portion 33. Therefore, the light guide film 30 where the light exit sheet 31 and the wedge-shaped light incident portion 33 are integrally formed into one can be manufactured in the present embodiment by using the continuous hot rolling process, so as to facilitate rapid mass production of the light guide film 30 and reduce the cost. It is worth mentioning that in the light guide film 20 shown in FIG. 2A and FIG. 2B, the wedge-shaped light incident portion 23 or 25 can be replaced with the wedge-shaped light incident portion 33 shown in FIG. 3A and FIG. 3B. Therefore, the light guide film 20 shown in FIG. 2A and FIG. 2B may also be designed to have an asymmetric structure.

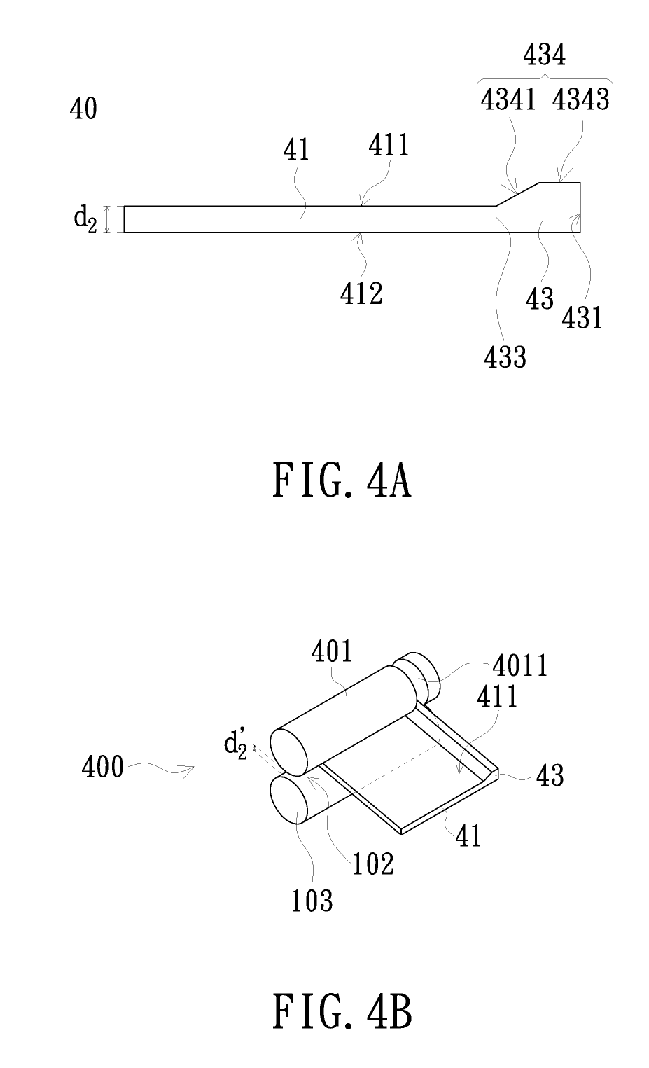

Please refer to FIG. 4A and FIG. 4B. FIG. 4A is a schematic cross-sectional view of a light guide film in accordance with yet another embodiment of the present invention. FIG. 4B is a schematic perspective view of a manufacturing method of a light guide film in accordance with yet another embodiment of the present invention. A light guide film 40 of the present embodiment and the light guide film 10 of the embodiment illustrated in FIG. 1A and FIG. 1B have similar structures and the same function and efficacy. The difference between the present embodiment and the embodiment illustrated in FIG. 1A and FIG. 1B is that a wedge-shaped light incident portion 43 of the light guide film 40 further has a connection surface 434, located between a light incident side surface 431 and a connection side 433 of the wedge-shaped light incident portion 43. A light exit surface 411 of a light exit sheet 41 is adjacent to the connection surface 434 and extends from a side of the connection surface 434.

The connection surface 434 includes a first connection plane 4341 and a second connection plane 4343. The light exit surface 411 of the light exit sheet 41 is adjacent to a side of the first connection plane 4341. The other side of the first connection plane 4341 is adjacent to a side of the second connection plane 4343. The other side of the second connection plane 4343 is adjacent to the light incident side surface 431. The first connection plane 4341 is not parallel to the second connection plane 4343. The light exit sheet 41 and the wedge-shaped light incident portion 43 are integrally formed into one. There is no boundary between the light exit sheet 41 and the wedge-shaped light incident portion 43.

The light exit sheet 41 and its light exit surface 411 and back surface 412 of the present embodiment may be the same as the light exit sheet 11 of the aforementioned embodiment. The wedge-shaped light incident portion 43 and its light incident side surface 431 and connection side 433 may be the same as the wedge-shaped light incident portion 13 of the aforementioned embodiment. Since a thickness at the light incident side surface 431 of the wedge-shaped light incident portion 43 is greater than a thickness at the connection side 433 of the wedge-shaped light incident portion 43, a thickness at the light incident side surface 431 of the light guide film 40 may be designed to match the width of the light exit side surface of the light source (not shown in the figure), so as to enhance the usage efficiency of the light source and reduce the occurrence of light leakage.

Please refer to FIG. 4B. The difference between a light guide film manufacturing equipment 400 and the light guide film manufacturing equipment 100 illustrated in FIG. 1B is that a first roller 401 of the light guide film manufacturing equipment 400 has a groove 4011 corresponding to the wedge-shaped light incident portion 43. When the material outputted by the feeding device (not shown in the figure) is extruded into a sheet form and outputted by the first roller 401 and the second roller 103, the wedge-shaped light incident portion 43 and the light exit sheet 41 integrally formed into one can be produced at a place corresponding to the groove 4011. There is no boundary between the light exit sheet 41 and the wedge-shaped light incident portion 43.

It is worth mentioning that in the light guide film 20 shown in FIG. 2A and FIG. 2B, the wedge-shaped light incident portion 23 or 25 may be replaced with the wedge-shaped light incident portion 43 shown in FIG. 4A and FIG. 4B. Therefore, the light guide film 20 shown in FIG. 2A and FIG. 2B may also be designed to have an asymmetric structure.

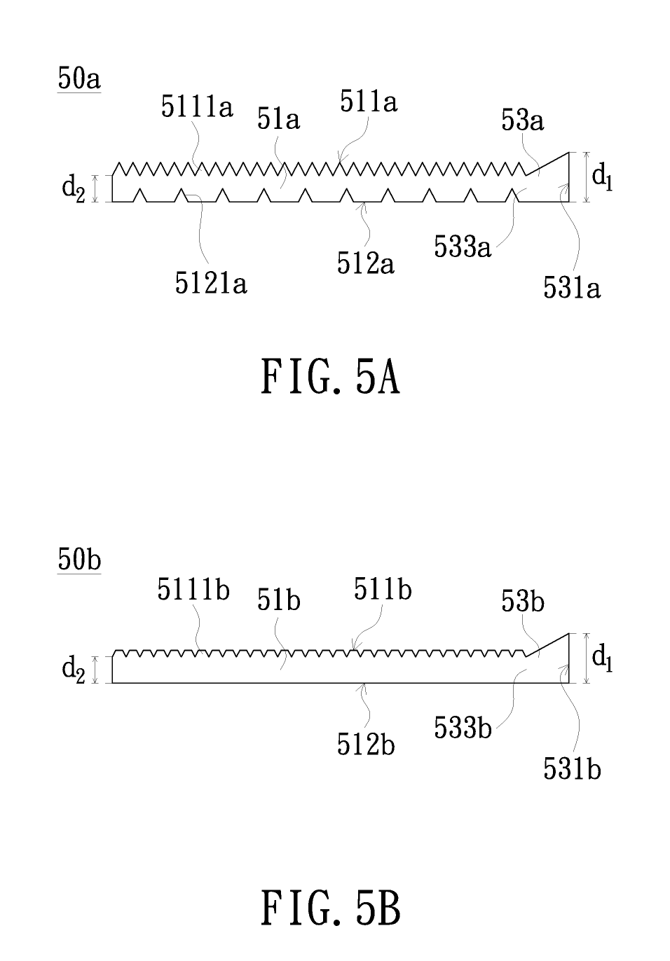

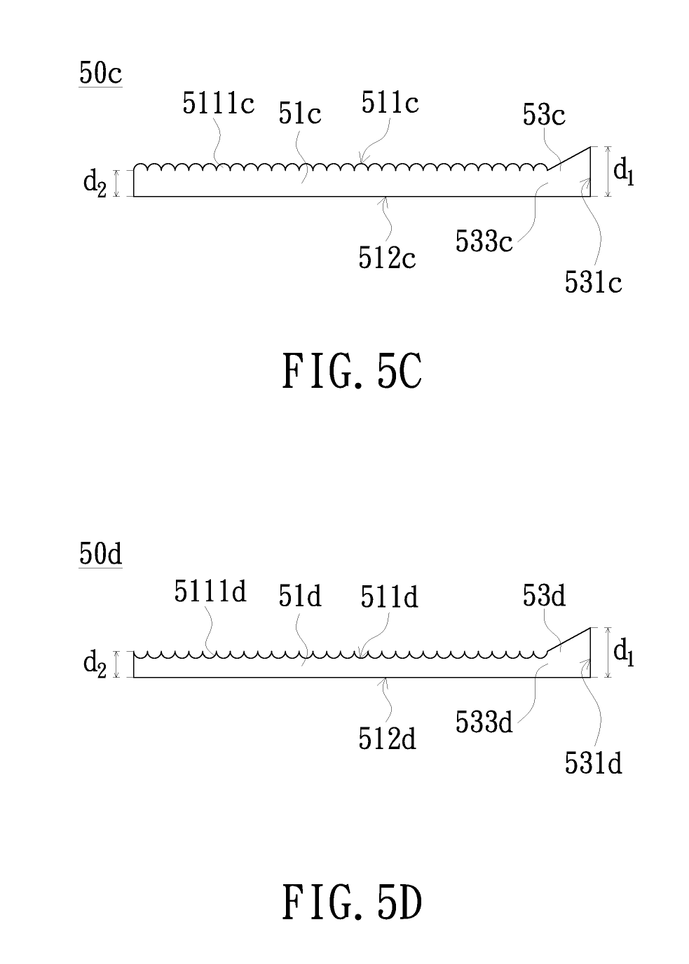

Please refer to FIG. 5A. FIG. 5A is a schematic cross-sectional view of a light guide film in accordance with yet another embodiment of the present invention. A light guide film 50a of the present embodiment and the light guide film 10 of the embodiment illustrated in FIG. 1A and FIG. 1B have similar structures and the same function and efficacy. The difference between the present embodiment and the embodiment illustrated in FIG. 1A and FIG. 1B is that a light exit sheet 51a further has an optical microstructure 5111a formed at a light exit surface 511a, and a scattering microstructure 5121a formed at a back surface 512a of the light exit sheet 51a opposite to the light exit surface 511a. The optical microstructure 5111a can deflect a light so that the light incident to the light exit sheet 51a can be emitted from the light exit surface 511a. The scattering microstructure 5121a is for scattering the light in the light exit sheet 51a, so that the light incident to the light exit sheet 51a can be emitted from the light exit surface 511a. Through the design of the optical microstructure 5111a and the scattering microstructure 5121a, the light usage efficiency of the light exit sheet 51a can be enhanced.

A wedge-shaped light incident portion 53a and its light incident side surface 531a and connection side 533a of the present embodiment may be the same as the wedge-shaped light incident portion 13 of the aforementioned embodiment. A manufacturing method of the light guide film 50a may be similar to the manufacturing method of the light guide film 10 shown in FIG. 1B, and only needs that a structure (not shown in the figure) corresponding to the optical microstructure 5111a is disposed on a pressing surface of the first roller 101 of the light guide film manufacturing equipment 100 and that a structure (not shown in the figure) corresponding to the scattering microstructure 5121a is disposed on a pressing surface of the second roller 103. When the material outputted by the feeding device (not shown in the figure) is extruded into a sheet form and outputted by the first roller 101 and the second roller 103, the optical microstructure 5111a can be formed on the light exit surface 511a of the light exit sheet 51a, and the scattering microstructure 5121a can be formed on the back surface 512a, so that the light guide film 50a is suitable for rapid mass production and reducing the cost. In other embodiments of the present invention, the optical microstructure 5111a and/or the scattering microstructure 5121a may also be formed, for example, through cutting with a knife tool, and the present invention is not limited thereto.

In the present embodiment, the optical microstructure 5111a is exemplified by including a plurality of side-by-side prism units. The prism units and the light incident side surface 531a of the wedge-shaped light incident portion 53a run in the same direction, so that a light incident to the light exit sheet 51a can be emitted from the light exit surface 511a. The scattering microstructure 5121a is exemplified by including a plurality of side-by-side V-cut grooves. The V-cut grooves and the light incident side surface 531a of the wedge-shaped light incident portion 53a run in the same direction, but the present invention is not limited thereto. In other embodiments of the present invention, the scattering microstructure 5121a may be, for example, a dot pattern. The dot pattern may be a plurality of grooves and/or bumps, and may also be dots made by a screen printing method. The present invention is not limited thereto.

Please refer to FIG. 5B. FIG. 5B is a schematic cross-sectional view of a light guide film in accordance with yet another embodiment of the present invention. A light guide film 50b of the present embodiment and the light guide film 10 of the embodiment illustrated in FIG. 1A and FIG. 1B have similar structures and the same function and efficacy. For example, a wedge-shaped light incident portion 53b and its light incident side surface 531b and connection side 533b of the present embodiment may be the same as the wedge-shaped light incident portion 13 of the aforementioned embodiment. A back surface 512b of a light exit sheet 51b may be the same as the back surface 112 of the aforementioned embodiment. In addition, a manufacturing method of the light guide film 50b of the present embodiment is approximately the same as the manufacturing method of the light guide film 50a of the aforementioned embodiment, and only the pressing surfaces of the rollers (for example, the first roller 101 and the second roller 103) are different.

The difference between the present embodiment and the embodiment illustrated in FIG. 1A and FIG. 1B is that the light exit sheet 51b further has an optical microstructure 5111b formed at a light exit surface 511b. The optical microstructure 5111b includes a plurality of side-by-side V-cut grooves. The V-cut grooves and the light incident side surface 531b run in the same direction. The optical microstructure 5111b can deflect a light so that the light incident to the light exit sheet 51b can be emitted from the light exit surface 511b, so as to enhance the light usage efficiency of the light exit sheet 51b.

Please refer to FIG. 5C. FIG. 5C is a schematic cross-sectional view of a light guide film in accordance with yet another embodiment of the present invention. A light guide film 50c of the present embodiment and the light guide film 10 of the embodiment illustrated in FIG. 1A and FIG. 1B have similar structures and the same function and efficacy. For example, a wedge-shaped light incident portion 53c and its light incident side surface 531c and connection side 533c of the present embodiment may be the same as the wedge-shaped light incident portion 13 of the aforementioned embodiment. A back surface 512c of a light exit sheet 51c may be the same as the back surface 112 of the aforementioned embodiment. In addition, a manufacturing method of the light guide film 50c of the present embodiment is approximately the same as the manufacturing method of the light guide film 50a of the aforementioned embodiment, and only the pressing surfaces of the rollers (for example, the first roller 101 and the second roller 103) are different.

The difference between the present embodiment and the embodiment illustrated in FIG. 1A and FIG. 1B is that the light exit sheet 51c further has an optical microstructure 5111c formed at a light exit surface 511c. The optical microstructure 5111c includes a plurality of side-by-side columnar structures. Each of the columnar structures has a convex cylindrical surface. The columnar structures and the light incident side surface 531c run in the same direction. The optical microstructure 5111c can deflect a light so that the light incident to the light exit sheet 51c can be emitted from the light exit surface 511c, so as to enhance the light usage efficiency of the light exit sheet 51c.

Please refer to FIG. 5D. FIG. 5D is a schematic cross-sectional view of a light guide film in accordance with yet another embodiment of the present invention. A light guide film 50d of the present embodiment and the light guide film 10 of the embodiment illustrated in FIG. 1A and FIG. 1B have similar structures and the same function and efficacy. For example, a wedge-shaped light incident portion 53d and its light incident side surface 531d and connection side 533d of the present embodiment may be the same as the wedge-shaped light incident portion 13 of the aforementioned embodiment. A back surface 512d of a light exit sheet 51d may be the same as the back surface 112 of the aforementioned embodiment. In addition, a manufacturing method of the light guide film 50d of the present embodiment is approximately the same as the manufacturing method of the light guide film 50a of the aforementioned embodiment, and only the pressing surfaces of the rollers (for example, the first roller 101 and the second roller 103) are different.

The difference between the present embodiment and the embodiment illustrated in FIG. 1A and FIG. 1B is that the light exit sheet 51d further has an optical microstructure 5111d formed at a light exit surface 511d. The optical microstructure 5111d includes a plurality of side-by-side columnar structures. Each of the columnar structures has a concave cylindrical surface. The columnar structures and the light incident side surface 531d run in the same direction. The optical microstructure 5111d can deflect a light so that the light incident to the light exit sheet 51d can be emitted from the light exit surface 511d, so as to enhance the light usage efficiency of the light exit sheet 51d.

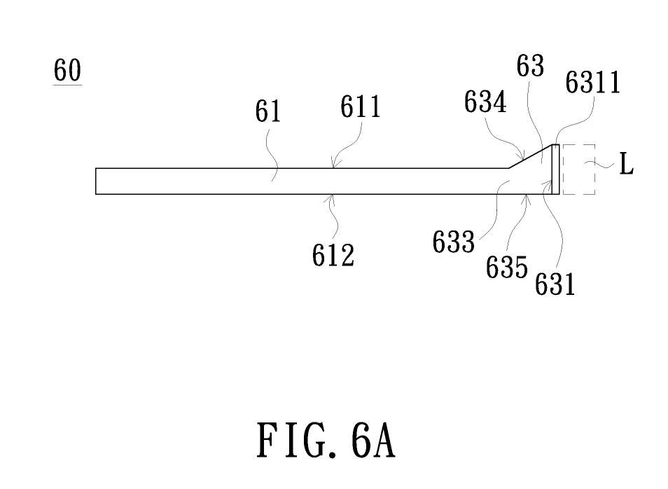

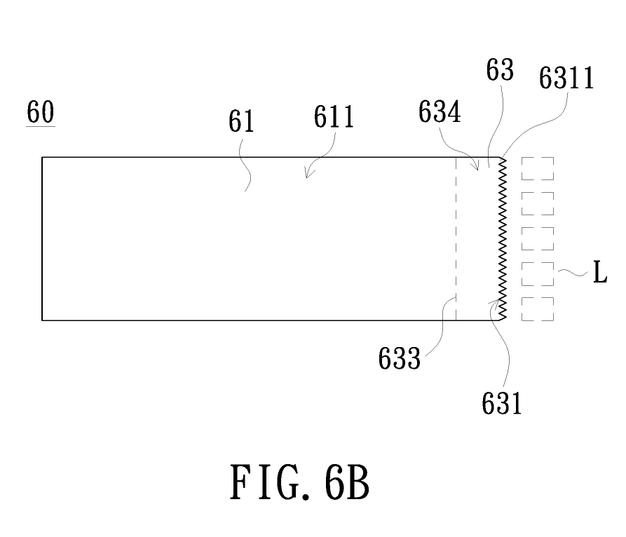

Please refer to FIG. 6A and FIG. 6B. FIG. 6A is a schematic cross-sectional view of a light guide film in accordance with yet another embodiment of the present invention. FIG. 6B is a schematic top view of a light guide film 60 in FIG. 6A. The light guide film 60 of the present embodiment and the light guide film 10 of the embodiment illustrated in FIG. 1A and FIG. 1B have similar structures and the same function and efficacy. The difference between the present embodiment and the embodiment illustrated in FIG. 1A and FIG. 1B is that a wedge-shaped light incident portion 63 further has a first plane 634 and a second plane 635. The first plane 634 is opposite to the second plane 635. The first plane 634 and the second plane 635 are located between a light incident side surface 631 and a connection side 633. A light exit surface 611 of a light exit sheet 61 is adjacent to the first plane 634 and extends from a side of the first plane 634. The first plane 634 is inclined relative to the light exit surface 611. The light exit sheet 61 further has a back surface 612 opposite to the light exit surface 611. The back surface 612 is adjacent to the second plane 635 and extends from a side of the second plane 635. In the present embodiment, the second plane 635 is flush with the back surface 612 as an example. The light exit sheet 61 of the present embodiment may be the same as the light exit sheet 11 of the aforementioned embodiment.

In the present embodiment, the wedge-shaped light incident portion 63 further has a diffusing structure 6311 formed at the light incident side surface 631. The diffusing structure 6311 is used for diverging a light incident to the light incident side surface 631. The diffusing structure 6311 is exemplified by including a plurality of side-by-side prismatic structures. The prismatic structures of the diffusing structure 6311 are arranged at the light incident side surface 631 and along the light incident side surface 631. Through the diffusing structure 6311 disposed at the light incident side surface 631, the light incident to the light incident side surface 631 can be effectively diverged. Problems with unevenness of the light incident to the wedge-shaped light incident portion 63, caused by that the light generated by the light source L is too concentrated, can be reduced. In addition, it is particularly noted that the diffusing structure 6311 shown in FIG. 6 may also be formed at the light incident side surface 331 of the wedge-shaped light incident portion 33 shown in FIG. 3A, so as to assist the light guide film 30 in FIG. 3A in allowing the light to be emitted evenly.

In summary, in the light guide film disclosed in the above embodiments, since the thickness at the light incident side surface of the wedge-shaped light incident portion is greater than the thickness at the connection side of the wedge-shaped light incident portion (equivalent to the thickness of the light exit sheet), the usage efficiency of the light source can be enhanced and the occurrence of light leakage can be reduced. Secondly, since the light exit sheet and the wedge-shaped light incident portion are integrally formed into one, i.e., there is no boundary between the light exit sheet and the wedge-shaped light incident portion, the light transmitted at the light guide film basically does not refract and reflect between the light exit sheet and the wedge-shaped light incident portion, so that the light can be emitted from the light exit sheet as much as possible to reduce the loss of the light.

While the invention has been described in terms of what is presently considered to be the most practical and embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light guide film, comprising:
at least one wedge-shaped light incident portion, having a light incident side surface and a connection side opposite to the light incident side surface, wherein a thickness at the light incident side surface of the wedge-shaped light incident portion is greater than a thickness at the connection side of the wedge-shaped light incident portion; and
a light exit sheet, connected to the connection side and extending from the connection side, wherein the light exit sheet has a light exit surface, the wedge-shaped light incident portion protrudes from the light exit surface, the light incident side surface is for receiving a light emitted from the light exit surface, and the light exit sheet and the wedge-shaped light incident portions are integrally formed into one.

2. The light guide film according to claim 1, wherein the light exit sheet further has an optical microstructure formed at the light exit surface, and the optical microstructure deflects the light.

3. The light guide film according to claim 2, wherein the optical microstructure comprises a plurality of side-by-side prism units, and the prism units and the light incident side surface run in the same direction.

4. The light guide film according to claim 2, wherein the optical microstructure comprises a plurality of side-by-side V-cut grooves, and a the V-cut grooves and the light incident side surface run in the same direction.

5. The light guide film according to claim 2, wherein the optical microstructure comprises a plurality of side-by-side columnar structures.

6. The light guide film according to claim 5, wherein the columnar structures and the light incident side surface run in the same direction.

7. The light guide film according to claim 5, wherein each of the columnar structures has a convex cylindrical surface.

8. The light guide film according to claim 5, wherein each of the columnar structures has a concave cylindrical surface.

9. The light guide film according to claim 1, wherein the light exit sheet further has a back surface opposite to the light exit surface and a scattering microstructure formed at the back surface, and the scattering microstructure is used for scattering the light in the light exit sheet.

10. The light guide film according to claim 1, wherein the light exit sheet further has a back surface opposite to the light exit surface, and the wedge-shaped light incident portion further protrudes from the back surface.

11. The light guide film according to claim 1, wherein the wedge-shaped light incident portion further has a diffusing structure formed at the light incident side surface, and the diffusing structure is used for diverging the light incident to the light incident side surface.

12. The light guide film according to claim 11, wherein the wedge-shaped light incident portion further has a first plane and a second plane, the first plane is opposite to the second plane, the first plane and the second plane are located between the light incident side surface and the connection side, the light exit surface is adjacent to the first plane and extends from a side of the first plane, and the first plane is inclined relative to the light exit surface.

13. The light guide film according to claim 12, wherein the diffusing structure comprises a plurality of side-by-side prismatic structures, and the prismatic structures are arranged at the light incident side surface and along the light incident side surface.

14. The light guide film according to claim 12, wherein the light exit sheet further has a back surface opposite to the light exit surface, and the back surface is adjacent to the second plane and extends from a side of the second plane.

15. The light guide film according to claim 14, wherein the second plane is inclined relative to the back surface.

16. The light guide film according to claim 14, wherein the second plane is flush with the back surface.

17. The light guide film according to claim 1, wherein a material constituting the light guide film comprises polycarbonate.

18. The light guide film according to claim 1, wherein the wedge-shaped light incident portion further has a connection surface located between the light incident side surface and the connection side, the connection surface comprises a first connection plane and a second connection plane,
wherein the light exit surface of the light exit sheet is adjacent to the first connection plane and extends from a side of the first connection plane, and the other side of the first connection plane is adjacent to a side of the second connection plane;
wherein the other side of the second connection plane is adjacent to the light incident side surface, and the first connection plane is not parallel to the second connection plane.

19. The light guide film according to claim 1, wherein a thickness of the light exit sheet is between 0.1 mm and 0.4 mm, and a thickness at the light incident side surface of the wedge-shaped light incident portion is between 0.3 mm and 0.5 mm.
